(19) United States
(12) Patent Application Publication
(10) Pub. No.: US 2016/0068346 A1
(43) Pub. Date: Mar. 10, 2016

(54) APPARATUS AND METHOD FOR TRANSFERRING EGGS

(71) Applicant: MOBA GROUP B.V., Barneveld (NL)

(72) Inventor: Hendrik VAN DEN BRINK, Barneveld (NL)

(21) Appl. No.: 14/783,155

(22) PCT Filed: Apr. 10, 2014
(86) PCT No.: PCT/NL2014/050228

§ 371 Date: Oct. 8, 2015

(30) Foreign Application Priority Data
Apr. 12, 2013 (EP) 13001897.1

(51) Int. Cl. B65G 29/00; B65G 49/05

(52) U.S. Cl. CPC B65G 29/00; B65G 49/05

(57) ABSTRACT

The present invention relates to an apparatus for transferring eggs from a upstream first endless roller conveyor (1) to a downstream second endless roller conveyor (2), wherein the eggs during transfer are guided by means of a star wheel unit (3), thereby rotating and taking over the eggs at the very downstream down going end of the first conveyor, guiding the eggs during a downward movement over a saddle (4), and releasing the eggs onto the very upstream end of the second conveyor (2), wherein the first conveyor (1) has a first transporting speed v1 and the second conveyor (2) has a second transporting speed v2, with substantially v2/v1=r, with r a real number>1, wherein at least the second conveyor is transporting the eggs in a transporting direction in a substantial horizontal plane, wherein the eggs are transferred onto an horizontal part of said second conveyor. The system of the invention has appeared very suitable for both remedying breakage of eggs, for increasing egg processing capacities, and for manufacturing conditions. The invention also provides a method for transferring eggs.

The present invention concerns an apparatus for transferring eggs from a upstream first endless roller conveyor to a downstream second endless roller conveyor,

wherein the eggs during transfer are guided by means of a rotating star wheel unit, taking over the eggs at a very downstream downgoing end of the first conveyor, guiding the eggs during a downward movement over a saddle, and releasing the eggs onto the very upstream end of the second conveyor,
wherein the first conveyor has a first transporting speed v1 and the second conveyor has a second transporting speed v2, with substantially v2/v1=r, with r a real number≧1,
wherein at least the second conveyor is configured to transport the eggs in a transporting direction in a substantial horizontal plane.

Such apparatus is known from the “SYNCHRO” series egg breaking machines as manufactured by the company PELBO (www.pelbo.it). More in particular this apparatus is that part of the egg breaking system where the eggs are supplied with a very well matched velocity to the breaker units. Said part is a well known supply roller conveyor having a velocity matched such that the eggs to be broken are transferred with an accordingly adapted velocity.

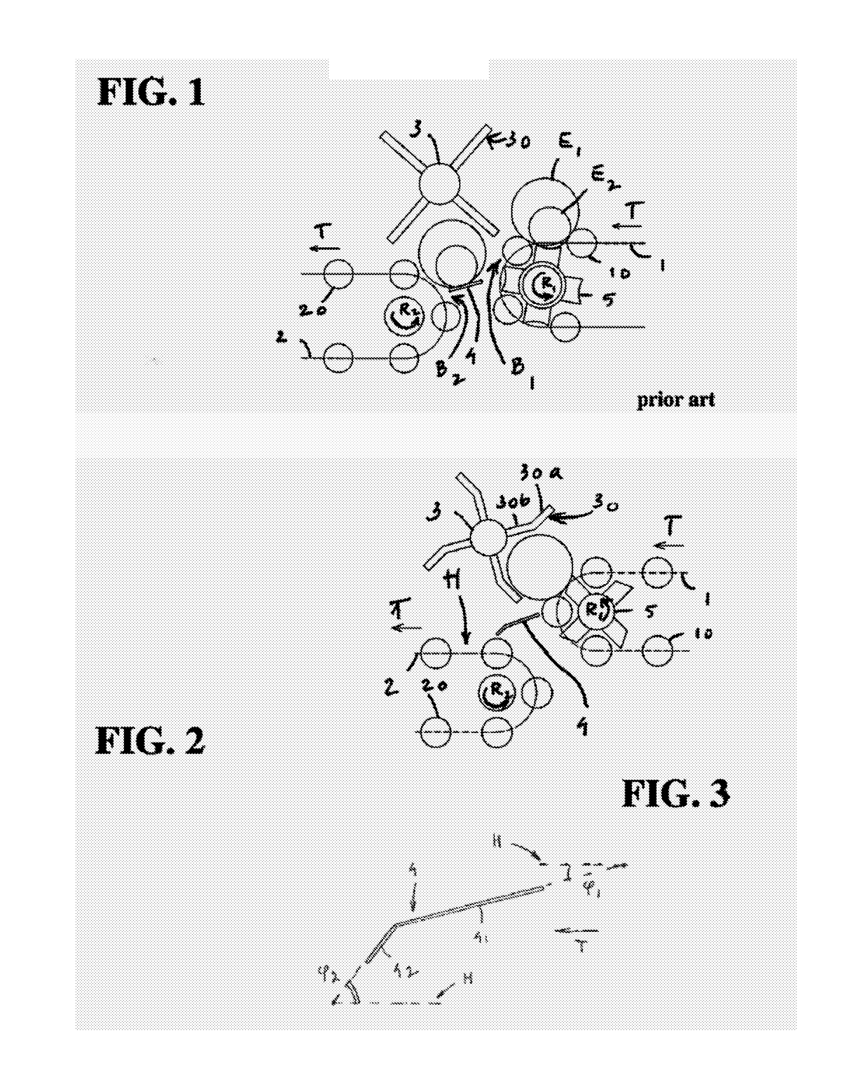

For having said eggs to be broken at such supply roller conveyor velocity, in turn said eggs have to be transferred to said supply roller conveyor (hereinafter supply conveyor) in a predetermined way. Such situation is shown in FIG. 1, giving schematically said prior art set-up.

In FIG. 1 as usual the eggs are guided to such egg breaking machine by means of an endless loader—conveyor system along a transport direction T. Such conveyor is moved for example by means of rotation of an end wheel axis in a rotation direction R1. In said system a loader conveyor 1 is a roller conveyor with rollers 10 arranged in rows, for receiving eggs from that loader. Eggs, for example of different sizes E1, E2, are transported while positioned and supported by a set of two subsequent rollers 10 of such row, a so-called pair of rollers 10, and thus every subsequent and adjacent pair of rollers 10. However said loader conveyor 1 has not the before said accordingly adapted velocity. Therefore the eggs E1, E2 are transferred from said loader conveyor 1 onto said supply conveyor 2 with help of a mill 3, often called star wheel 3, to guide the eggs over a saddle (or “guide element”) 4 and to induce the right direction and the right speed for such eggs. The saddle (i.e. guide element) 4 is located opposite the revolving star wheel 3, on a level below that wheel 3. During operations, eggs are guided over an upper guiding surface of the saddle 4, from the loader conveyor 1 to the supply conveyor 2, as follows from the drawings. As follows from the drawings, the star wheel includes a set of radially prongs 30 extending in radial directions (i.e. radially with respect of a central axis of rotation of the wheel 3).

In the prior art system, guidance of eggs E1, E2 is such that they are released from the loader conveyor 1 at the bent portion B1 of the downstream end of said conveyor 1 whereas they are received in an according bent portion B2 of the upstream end of the supply conveyor 2. As shown in FIG. 1 the direction of rotation of an upstream end wheel of the supply conveyor 2 is R2. More in particular the speed of the supply conveyor 2 is doubled compared to the speed of the loader conveyor 1.

The above situation needs very careful setting of velocities and sizing the parts in order to satisfy said matched velocity conditions which should guarantee transfer of eggs without problems such as damaging egg shells during falling and receiving.

Nevertheless it has appeared that a greater velocity at the in feed part accordingly more risky transfers of eggs result. Far more than before eggs are not sustaining such condition and break.

In order to solve such problem in accordance with the present invention the apparatus is characterized by the features of claim 1.

According to an aspect of the invention, the eggs are transferred onto an horizontal part of said second conveyor. Particularly, the apparatus is configured such that the eggs are transferred onto an upper horizontal section of the second conveyor. Particularly, an upper section of the first conveyor as well as the saddle can be arranged at a vertical level that is higher than a vertical level of the horizontal upper section of the second conveyor, with the saddle being configured and arranged to receive eggs from the upper section of the first conveyor, and to guide those eggs towards the upper horizontal section of the second conveyor (particularly in cooperation with the star wheel unit).

It has appeared that transfer in accordance with the invention remedies breakage of eggs substantially, whereas capacities result as desired.

Particularly, the system of the invention has appeared very suitable for both remedying breakage of eggs, for increasing egg processing capacities, and for manufacturing conditions.

More in particular the apparatus in accordance with the invention is characterized by one or more of the following features:

the saddle has a downward slope having at least one angle with the horizontal part (i.e. with a horizontal plane), with a range for said angle φ, comprising 10°<φ<60°;
the saddle has two downward slopes (having according two angles φ1, φ2, in the downstream direction, with 10°<φ1<40° and 30°<φ2<60°; and/or the saddle is a curved part having at their distal ends tangent angles φ1, φ2, with 10°<φ1<40° and 30°<φ2<60°.

Having such saddle has appeared very suitable to guide the eggs continuously without the problem of having double positioning on such pair of rollers.

In further embodiments of the invention the apparatus is characterized by one or more of the following features,

the loader conveyor and the supply conveyor have substantially the same roller distances; and
the eggs are transported by and positioned on every second subsequent pair of rollers.

Especially the latter measure is a very advantageous one thus having the same roller conveyors thereby avoiding different dimensions and settings, as a result of different manufacturing conditions.

Hereinafter a non-limiting example of the invention will be explained in more detail, thereby referring to a drawing,

with FIG. 1 showing schematically a side view of a prior art apparatus,

with FIG. 2 showing schematically a side view of an embodiment of the apparatus of the present invention, and

with FIG. 3 giving a detail of FIG. 2.

In the respective FIGURES the same or similar numbers and sign represent the same or similar parts and situations.

In FIG. 1 as discussed hereinabove a prior art system has been shown. Further to said discussion a pusher wheel 5 is arranged in order to push the eggs E1, E2 at the right moment during passing the bent portion B1 in the right direction. Because of having this measure differences in timing for small eggs and large eggs is reduced. It might be clear from FIG. 1 that the pusher wheel is arranged on the same axis as the end wheel of loader conveyor 1. Furthermore a star wheel 3 as explained before is used for guiding the eggs E1, E2 more smoothly over said egg guiding saddle 4. As shown guidance is applied in particular by a plate or a set of prongs 30 (of the wheel 3).

In FIG. 2 a suchlike situation as shown in FIG. 1 has been presented. The innovative apparatus includes:

an upstream first endless roller conveyor 1 (upstream being upstream with respect to the transporting direction T);
a downstream second endless roller conveyor 2 (downstream being downstream with respect to the transporting direction T);
egg transfer means including a rotating star wheel unit 3 and a (in this case stationary) saddle 4, configured for guiding the eggs from the first to the second conveyor;
wherein during operation the first conveyor 1 has a first transporting speed v1 and the second conveyor 2 has a second transporting speed v2, with substantially v2/v1=r, with r a real number≧1 (i.e. v2>v1);
   wherein the configuration is such that the eggs are transferred onto an horizontal part of said second conveyor (particularly the horizontal upper part of the second conveyor).

The embodiment of FIG. 2 differs from the apparatus shown in FIG. 1 in a difference in height between loader conveyor 1 and supply conveyor 2. Particularly, the loader conveyor 1 is positioned on a relatively high level with respect to the upper horizontal section of the downstream supply conveyor 2, wherein intermediate transfer means 3, 4 can receive eggs from the loader conveyor 1 and deposit these eggs onto the upper horizontal section of the downstream supply conveyor 2. In other words: the height difference enables to have the saddle 4 above supply conveyor 2, more in particular to arrange the saddle 4 above the (vertical) level of a horizontal part H of said supply conveyor 2. As a result, the eggs E1, E2 can be guided directly onto that horizontal part H, and to give the eggs the right supply conveyor velocity (in horizontal transport direction T).

In FIG. 3 a more specific embodiment of the saddle 4 has been presented schematically. In this embodiment the saddle has a two part structure, including two downward slope parts that extend at an angle (i.e. not in-line) with respect to each other. More in particular, further to an average slope having angle φ, with 10°<φ<60°, such two part structure has two sections extending at two respective downward slopes at two respective angles φ1, φ2, in the downstream direction, with 10°<φ1<40° and 30°<φ2<60°. Particularly, in this example, the angle φ1 of the first section 41 is smaller than the angle φ2 of the subsequent (downstream) second section 42 of the saddle 4. As clearly shown said angles φ, φ1, φ2 are taken in relation to the direction of the horizontal part H (i.e. angles φ, φ1, φ2 that are enclosed by the respective saddle section with a horizontal line or horizontal plane, extending in parallel with the horizontal part H of the supply conveyor 2).

In a further, alternative, embodiment the saddle is a curved part or element, having two distal ends (i.e. the ends that are faced away from each other), wherein the distal ends as such extend along the angles φ1, φ2, with 10°<φ1<40° and 30°<φ2<60° (and φ1<φ2), with φ1 relating to the distal end that faced the first conveyor 1, with φ2 relating to the distal end that faced the second conveyor 2 (similar to the arrangement shown in FIG. 2).

For a skilled person it might be clear that many options can be followed to arrive at the condition for the respective velocities, for example for r=2 giving substantially v2/v1=2, however different ratios might be preferred.

In an advantageous embodiment the eggs are transported by and positioned on every second subsequent pair of rollers.

Furthermore in FIG. 2 the plate or prongs 30 for guiding the eggs E have parts 30a, 30b, giving guidance and transfer which in combination with a distance to a central wheel axis more fitting to the desired ratio of velocities. More in particular as shown in this embodiment such parts may be chosen as a bent plate or as bent prongs 30a, 30b, having well chosen bent angles. However, for a skilled person it is quite clear that further embodiments are possible, for example articulating parts or portions 30a, 30b, or even extensible parts 30a, 30b by means of a unit for telescopically moving such parts. Furthermore combinations of such structures are possible as well.

It might be clear to a skilled person that, while specific embodiments have been described above, the invention may be practiced otherwise than as described. The descriptions above are intended to be illustrative, not limiting. Thus, it will be apparent to one skilled in the art that modifications may be made to the invention as described in the foregoing without departing from the scope of the claims set out below.

1. Apparatus for transferring eggs from a upstream first endless roller conveyor to a downstream second endless roller conveyor,
wherein the eggs during transfer are guided by means of a star wheel unit,
thereby rotating and taking over the eggs at the very downstream down going end of the first conveyor, guiding the eggs during a downward movement over a saddle, and releasing the eggs onto the very upstream end of the second conveyor,
wherein the first conveyor has a first transporting speed v1 and the second conveyor has a second transporting speed v2, with substantially v2/v1=r, with r a real number≧1,
wherein at least the second conveyor is transporting the eggs in a transporting direction in a substantial horizontal plane, and
wherein the eggs are transferred onto an horizontal part of said second conveyor.

2. Apparatus of claim 1, characterized in that,
for the first transporting speed v1 and for the second transporting speed v2, said ratio v2/v1 is substantially equal to 2.

3. Apparatus in accordance with claim 1, characterized in that,
the loader conveyor and the supply conveyor have substantially the same roller distances.

4. Apparatus in accordance with claim 1, characterized in that,
the eggs are transported by and positioned on every second subsequent pair of rollers.

5. Apparatus in accordance with claim 1, characterized in that,
the saddle has a downward slope having at least one angle with the horizontal part, with a range for said angle φ, comprising 10°<φ<60°.

6. Apparatus of claim 5, characterized in that,
the saddle has two downward slopes having according two angles φ1, φ2, in the downstream direction, with 10°<φ1<40° and 30°<φ2<60°.

7. Apparatus of claim 6, characterized in that,
the saddle is a curved part having at their distal ends tangent angles φ1, φ2, with 10°<φ1<40° and 30°<φ2<60°.

8. Apparatus in accordance with claim 1, characterized in that,
the star wheel unit has for example plates or prongs having at least a two part structure.

9. Apparatus in accordance with claim 8, characterized in that, the two part structure comprises for example a bent plate or bent prongs having a well defined bend angle.

10. Apparatus in accordance with claim 9, characterized in that, the two part structure comprises for example a bent plate or bent prongs having a bending unit for articulating said parts.

11. Apparatus in accordance with claim 8, characterized in that, the two part structure comprises a unit for extending said parts telescopically.

12. Method for transferring eggs from a upstream first endless roller conveyor to a downstream second endless roller conveyor, for example use of an apparatus according to claim 1, the method including:
guiding the eggs during transfer by means of a star wheel unit, thereby rotating and taking over the eggs at a end of the first conveyor,
guiding the eggs via a saddle onto an upstream end of the second conveyor,
wherein the first conveyor has a first transporting speed v1 and the second conveyor has a second transporting speed v2, with substantially v2/v1=r, with r a real number≧1,
wherein at least the second conveyor is transporting the eggs in a transporting direction in a substantial horizontal plane, and
wherein the eggs are transferred onto an horizontal part of said second conveyor.
